(19) United States
(12) Patent Application Publication
(10) Pub. No.: US 2023/0313071 A1
(43) Pub. Date: Oct. 5, 2023

(54) LIQUID DETERGENT CONCENTRATE

(71) Applicant: Hans Georg HAGLEITNER, Zell am See (AT)

(72) Inventor: Hans Georg HAGLEITNER, Zell am See (AT)

(21) Appl. No.: 18/200,401

(22) Filed: May 22, 2023

Related U.S. Application Data
(63) Continuation-in-part of application No. 15/768,770, filed on Apr. 16, 2018.

(30) Foreign Application Priority Data
Oct. 16, 2015 (EP) 15190193.1

(51) Int. Cl. C11D 3/04; C11D 3/20; C11D 3/30; C11D 13/12; C11D 17/00

(52) U.S. Cl. CPC C11D 3/044; C11D 3/2082; C11D 3/30; C11D 13/12; C11D 17/0013

(57) ABSTRACT

A detergent concentrate includes:
(i) 22 to 46% by weight alkali metal hydroxide,
(ii) 5 to 50% by weight dispersing agent, chelating agent or a combination thereof,
(iii) 0 to 5% by weight tenside,
(iv) 0 to 5% by weight excipients and
(v) 28 to 39% by weight water,
wherein the detergent concentrate is a suspension. Also disclosed are methods of production therefor.

### CROSS REFERENCE TO RELATED APPLICATIONS

This application is a continuation-in-part of U.S. patent application Ser. No. 15/768,770, filed Apr. 16, 2018, which is a 371 of International Patent Application No. PCT/EP2016/074744, filed Oct. 14, 2016, which claims the benefit of European Patent Application No. 15190193.1, filed Oct. 16, 2015, which are incorporated herein by reference in their entirety.

### BACKGROUND

The invention relates to a liquid detergent concentrate, comprising at least one alkali metal hydroxide. The invention further relates to a method for producing a liquid detergent concentrate comprising alkali metal hydroxide.

In order to clean dishes, in particular to remove dirt adhering to dishes, it is preferable to use alkali detergents.

Liquid detergents on the basis of hydroxides and chelating agents are known from the prior art and have advantages over powder-like formulations. On the one side, dust is avoided and, on the other side, handling in context of metering is facilitated by way of pumps.

Liquid detergent concentrates comprising an alkali metal hydroxide are described, e.g., in the DE 199 06 660 A1, wherein there is disclosed a water content of 53-80% by weight. Such high water content in liquid detergents, however, is disadvantageous for the stability of the concentrate and considerably increases the required volume of detergent concentrate, which involves additional packages. Especially on the commercial level, highly concentrated detergent concentrates having a small volume are preferred for reasons of storage and transport as well as environmental protection.

In order to counteract the disadvantages of high water content, various strategies have been pursued in the prior art. Non-aqueous liquid detergent concentrates such as those described in the EP 1 181 346 constitute a strategy; such compositions, however, are associated with a lower cleaning performance and involve the handling of health-hazardous or environmentally critical chemical agents. U.S. Pat. No. 4,040,098 to Renaud et al. Disclosed a low viscosity detergent containing no alkali metal hydroxide and thus would be expected to have poor cleaning ability.

Another approach is the reduction of the water concentration in aqueous detergent concentrates, which will lead, however, to an increase of viscosity. In the DE 100 02 710 A1 there is described, e.g., a paste-form detergent concentrate having a water proportion of 32.5% and viscosity. The viscosity is described as being about 20,000-300,000 mPa·s, measured at 20° C. with a Brookfield viscosimeter at 5 revolutions per minute.

U.S. Publication No. 2014/0121150 to Walters et al. discloses both liquid and solid detergent compositions containing 20-90% of an alkali metal hydroxide and up to 90% water. However, the main focus of Walters is how to make solid detergent compositions, which have a water concentration between about 0.01-40%, preferably about 0.1-35%, more preferably about 1-30%.

Detergent concentrates are metered on an industrial level using metering devices and automatically diluted with water to the desired final concentration in the ready-to-use detergent. In such metering devices, there are usually used pinch pumps for metering the detergent concentrate, wherein these pinch pumps are only able to meter liquid detergent concentrates. Cream-like or paste-like, respectively, detergent concentrates are not suitable for the use in metering devices due to the high viscosity—in the worst case, this will lead to obstruction and destruction of the pinch pump or of the metering device.

### SUMMARY

Hence, it is the object of the present invention to provide a highly concentrated but still liquid detergent concentrate on the basis of alkali metal hydroxide, which may be metered and diluted using a metering device.

In some embodiments, this task is solved by a liquid detergent concentrate, comprising
(i) 22 to 46% by weight alkali metal hydroxide,
(ii) 5 to 50% by weight dispersing agent, chelating agent or a combination thereof,
(iii) 0 to 5% by weight tenside,
(iv) 0 to 5% by weight excipients, and
(v) 28 to 39% by weight water,
wherein the detergent concentrate is a suspension.

There is preferably provided that this suspension has a viscosity of at the most 6500 mPa·s, measured according to ISO 2555:1989 at a rotational speed of 5 rpm. The measurement may be carried out using a Brookfield viscometer, for example. Although a detergent composition having such high alkali metal hydroxide content and such low water content would be expected to be a solid according to Walters, or a highly viscous paste according to DE '660, as mentioned above, the manner in which the components are mixed together as a suspension was surprisingly and unexpectedly able to yield a liquid detergent that is only moderately viscous.

The suspensions described herein are stable suspensions.

Within the scope of the invention, it has been found that the reduction of the water proportion and the increase of viscosity usually associated therewith may be prevented if the detergent concentrate is produced in the form of a suspension. This was unknown from the prior art.

There is preferably provided that the detergent concentrate does not contain any other ingredients.

The production of a stable suspension, which has a high concentration of alkali metal hydroxide in a small amount of water, however, is not possible using conventional methods for producing suspensions. It is not possible to produce stabile alkali metal hydroxide suspensions using known production methods for suspensions according to prior art, and as far as (non-stable) suspensions may be produced these have such a high viscosity such that metering is impossible.

The present invention, hence, involves a method for producing a stable suspension.

The task is solved by a method for producing a suspension, comprising
(i) 22 to 46% by weight alkali metal hydroxide,
(ii) 5 to 50% by weight dispersing agent, chelating agent or a combination thereof,
(iii) 0 to 5% by weight tenside,
(iv) 0 to 5% by weight excipients and
(v) 28 to 39% by weight water, dissolved, wherein the method comprises the following steps:
   a) providing a portion of a dispersing agent, chelating agent, or a combination thereof in an aqueous solution,
   b) optionally adding excipients,
   c) in the case of the addition of excipients, subsequently adding a further portion of a dispersing agent,
   d) adding a portion of an alkali metal hydroxide as an aqueous solution,
   e) optionally adding a tenside,
   f) adding a further portion of an alkali metal hydride,
   g) adding a dispersing agent,
   h) adding a further portion of an alkali metal hydroxide,
wherein the steps of addition are carried out while stirring and wherein at least the addition steps d) to h) are carried out such that in the aqueous phase there is maintained a temperature of at the most 40° C., preferably at the most 35° C.

As used herein, “adding a portion” means that only a part and not the entire amount of the respective ingredient is added in the respective step.

Using such a method it is possible to produce a stable suspension—i.e., a suspension, which does not separate during storage or use, respectively, and in which there is no precipitation and no solid is deposited, respectively. In this way, it is for the very first time possible to produce a stable suspension comprising large amounts of alkali metal hydroxide, and—in contrast to the paste-like composition according to DE 100 02 710 A1—it is possible to produce a liquid detergent concentrate that may be pumped and metered.

### DETAILED DESCRIPTION

### Terms

Within the scope of this invention, the terms mentioned in the application are to be construed as such:

A “detergent” represents a ready-to-use preparation for cleaning, and it is a mixture of a detergent concentrate with water. The detergent is preferably a ready-to-use preparation for cleaning dishes.

A “detergent concentrate” is a composition, wherein the ingredients—with the exception of the diluent water—are present in a higher concentrated form than in the ready-to-use detergent.

A “stable suspension” means a suspension that does not separate during storage and use and which does not form precipitates. The stability may, for example, be measured by measuring the viscosity and the density, which may change only insignificantly over time (e.g., over a period of 3-12 months). The stability may also be determined by means of a climate change test or storage over a defined period time and subsequent optical inspection (separation in two or several phases). One way of measurement is to examine whether the viscosity and the density have changes by less than 5% upon 30 days of storage, i.e. without stirring or moving the suspension, at 20° C. via sedimentation.

“Alkali metal hydroxides” mean hydroxides of at least one alkali metal. This may thus also be a mixture of several alkali metal hydroxides. Preferred alkali metal hydroxides used in the disclosed detergent compostions are sodium hydroxide (NaOH) and potassium hydroxide (KOH).

A “dispersing agent” is an additive that improves the optimum blending of at least two substances that are actually immiscible. Dispersing agents can also improve the cleaning performance of the detergent. The dispersing agent can be a mixture of two or several dispersing agents. A dispersing agent in the detergent furthermore supports the disintegration of deposits.

A “chelating agent” is an additive that forms chelate complexes with metal ions. In this way, undesired properties of certain metal ions are masked. In the cleaning process, in particular divalent metal ions are undesired, especially alkaline earth metal ions like Ca²⁺ and Mg²⁺. For this reason, there are preferred chelating agents that form complexes with alkaline earth metal ions.

In detergents, some chelating agents also act as dispersing agents and vice versa.

“Tensides” are substances that reduce the surface tension of a liquid or the interfacial tension between two phases and, in this way, support the formation of dispersions. They may also act as solubilizers. There may also be present a mixture of two or several tensides.

In detergents, tensides function to support the transition of the fat and dirt particles adhering to the dishes into the aqueous phase. These may, for example, be selected from the group of the alkyl benzene sulfonates, alkyl polyglycosides, esterquats, fatty alcohol ethoxylates, fatty alcohol sulphates and fatty alcohol ether sulphates or mixtures thereof, wherein fatty alcohol ethoxylates exhibit an especially good cleaning performance.

“Excipients” include compounds that may facilitate the use thereof in the final preparation of the detergent or which may enhance the cleaning activity thereof. Excipients, however, may also include compounds, which support the formation of suspensions. Typical excipients are, for example: defoaming agents, i.e. substances, which reduce the formation of undesired foams upon stirring of the detergent, thickening agents, which increase the viscosity of the detergent, detergency boosters, which enhance the cleaning activity of alkali metal hydroxides, threshold substances, suspensing agents or also flavours, to mention only a few examples.

“Defoaming agents” may, for example, be selected from the group of the paraffin oils, silicon oils or mixtures thereof. An example of a possible paraffin oil is technical white oil (company Bussetti); an example of a silicon oil is silicon oil 100 (company Bussetti). The content of defoaming agent may, for example, be 0 to 5% by weight.

“Thickening agents” may, for example, be selected from the group of 1,2,3-propane triol, propane-2-ol, xanthan gum (e.g., Keltrol types, company CP Kelco). The content of thickening agents may, for example, be 0 to 5% by weight.

“Detergent boosters” may be substances, for example, which have an alkali activity, i.e. they may act to increase the pH, and they may be, e.g., monoethanol amine or triethanol amine. Other detergency boosters include polymers or alkali compounds, such as Mirapol SURF S (a mixture on the basis of Na₂CO₃; company Rhodia), Polyquart Ampho 149 (company BASF). The content of detergency boosters may, for example, be 0 to 5% by weight.

“Suspending agents” may be, e.g., selected from the group of polyvinyl alcohol or polyvinyl pyrrolidone. The content of suspending agent may be, e.g., 0 to 2% by weight. There is preferably not provided a suspending agent, as it has been demonstrated that in the case of increasing amounts of suspensing agents this will result in separation and formation of deposits.

“Threshold substances” are compounds that prevent, or at least significantly retard, the formation of precipites at very low (sub-stoichiometric) concentrations. In an over-saturated solution, the formation of an insoluble precipitation is prevented by threshold substances blocking the surface of the microcrystals developing first by way of adsorption such that it is not possible for larger crystals to be formed. In the detergent industry there are known as threshold substances, e.g., compounds of the group of low molecular weight phosphonates and the high molecular weight chelating agents (e.g., polycarboxylates).

An especially suitable threshold substance is Hydrodis WP 40 having an oligomeric phosphonic acid as the major component. Although it has been known that many threshold active substances have problems with solubility in aqueous solutions at high calcium concentrations (aka calcium sensitivity), there was not shown a Ca-sensitive zone upon the addition of an oligomeric phosphonic acid in the form of Hydrodis WP 40. The addition of Hydrodis WP 40 promotes that the detergent concentrate remains stable and has very good calcium bonding ability as well as a good cleaning performance. The content of the threshold substance is preferably 2 to 5% by weight.

In the following, further advantages and details of the invention are explained. The explanations relate to the liquid detergent concentrate and the production method for the suspension likewise. Due to considerations regarding the better understanding thereof, the production method is the first to be described in greater detail.

### Step a) Providing a Portion of a Dispersing Agent, Chelating Agent or a Combination Thereof in an Aqueous Solution:

First, there is provided a solution of a dispersing agent, chelating agent or a combination thereof in water.

There is preferably provided a mixture of a first and a second chelating agent.

A first chelating agent may, for example, be selected from the group of the amino carboxylic acids, and a second chelating agent may be selected from the group of amino phosphonic acids.

In a first embodiment variant, in step a) there may be provided a mixture of an aqueous solution of the first chelating agent (such as an amino carboxylic acid, more preferred an methyl glycine di-acetic acid or a salt thereof), and an aqueous solution of a second chelating agent (such as an amino phosphonic acid, more preferred an diethylene triamine pentamethylene phosphonic acid or a salt thereof).

### Step b) Optionally Adding Excipients,

In step b), there may be added excipients.

### Step c) Adding a Further Portion of a Dispersing Agent:

If excipients are added, then it is advantageous to add a further portion of a dispersing agent in a subsequent step. The addition of excipients and the subsequent addition of dispersing agents will lead to a more stable suspension.

### Step d) Adding a Portion of an Alkali Metal Hydroxide as an Aqueous Solution:

In step d), a first addition of alkali metal hydroxide is carried out while stirring, namely as an aqueous solution. Based on the total amount of alkali metal hydroxide, in this step there is preferably added less than the half, in particular preferably less than a third of the final amount of alkali metal hydroxide.

Aqueous solutions NaOH or KOH are preferred, there being no difference whether a NaOH solution or a KOH solution is used and whether an NaOH solution and a KOH solution are added separately or an NaOH/KOH mixture is used. There are also possible any combinations thereof.

### Step e) Adding a Tenside:

In step e), there is added a tenside while stirring.

### Step f) Adding a Portion of an Alkali Metal Hydride:

In step f), there is added a further portion of an alkali metal hydride as a solid. The addition is preferably carried out by adding NaOH and/or KOH pellets while stirring.

### Step g) Adding a Further Portion of a Dispersing Agent:

In step g), there is carried out the addition of a further portion of a dispersing agent, which is introduced while stirring.

### Step h) Adding a Further Portion of an Alkali Metal Hydroxide:

In step h), there is slowly added the still lacking amount of alkali metal hydroxide while stirring, wherein at least a part, preferably the entire amount of alkali metal hydroxide still lacking, is added as a solid. The addition is preferably carried out by introducing NaOH and/or KOH pellets while stirring.

### Temperature at Most 40° C., Preferably at Most 35° C., for the Addition Steps d) to h):

From step d) on, the aqueous phase must not reach a temperature exceeding 40° C. The inventors have found that the steps d) to h) have to be carried out at temperatures in the range between 15° C. and at the most 40° C. in order to obtain a stable suspension having the properties mentioned above. In the temperature range of 15 to 35° C., there was not exhibited an influence of the temperature on the stability and viscosity of the suspension. With increasing temperatures, the solubility of NaOH and/or KOH will increase gradually. If, however, the temperatures were above 40° C. during the addition, then it was not possible to obtain a stable, meterable suspension, as the detergent concentrate did have a paste-like consistence upon cooling.

Further it has been shown that the suspension prepared according to the invention thickened irreversibly upon cooling after heating to temperatures above 60° C., which is to be ascribed to a disadvantageous impairment of the suspension.

Temperature control can be achieved, for example, by way of cooling (e.g., using a cooling collar) or by a correspondingly slow process control. In step d), it may be useful to add an already finished solution of alkali metal hydroxide such that no noteworthy increase in temperature will occur.

There is preferably provided an active external cooling (e.g., cooling collar).

For the preparation of the suspension there may be provided a stirrer, for example an anchor stirrer.

In an embodiment variant, there is additionally provided a dispersing means in order to accelerate the formation of a suspension.

The inventors have surprisingly found that it is advantageous for two reasons to add at least in part KOH as alkali metal hydroxide to the composition. Basically, the person skilled in the art will prefer NaOH to KOH for various reasons.

In comparison with NaOH, KOH is more expensive. Furthermore, the cleaning performance of a pure KOH solution for cleaning dishes is (slightly) worse than the cleaning performance of a pure NaOH solution. Furthermore, KOH has been known for having a stronger reaction with CO₂ from air than NaOH and for carbonates being formed in the solution (“formation of deposits”). Finally, pure KOH has a stronger exothermic action in the dissolution process (solution enthalpy—57.1 kJ/mol) than NaOH (solution enthalpy—44.5 kJ/mol), which would in principle discourage any person skilled in the art to use KOH if a lower temperature is to be maintained in the aqueous phase.

Within the scope of the invention the inventors, however, found that the absorption of CO₂ when adding KOH will lead to less formation of deposits than when using pure NaOH. The formation of deposits is undesired as the suspension is conveyed to the pump via a suction lance and the deposits may obstruct the suction lance. For this reason, the presence of KOH is preferred.

In spite of a fundamentally higher exothermic action upon dissolution of KOH it has been shown that, when KOH pellets are added in step f), the spontaneous increase in temperature was unexpectefly less than with the addition of NaOH pellets such that it is easier to control the process.

In regard to the composition of the liquid detergent concentrate, which is a suspension, there could be gained the following findings:

### (i) 22 to 46% by Weight Alkali Metal Hydroxide:

Dish detergents exhibit the best cleaning performance at high concentrations of alkali metal hydroxide. For the present invention, an addition of up to 46% by weight of alkali metal hydroxide was possible, by means of which a stable suspension could be obtained, the viscosity of which being within the range mentioned.

Due to the reasons mentioned above, NaOH (22 to 46% by weight), KOH (22 to 46% by weight) or mixtures thereof (NaOH: 25 to 46% by weight—x % by weight; KOH: x % by weight) are preferred.

The highest stability of the suspension was obtained using a mixture of NaOH and KOH, wherein the content of KOH was between 5 and 10% by weight.

### (ii) 5 to 50% by Weight Dispersing Agent, Chelating Agent, or a Combination Thereof:

An especially good cleaning activity of the detergent was obtained when there are present in the detergent concentrate at least one dispersing agent and at least one chelating agent. Especially preferably, the dispersing agent comprises a polymeric dispersing agent. A preferred detergent concentrate comprises 1 to 10% by weight of a polymeric dispersing agent.

In a preferred embodiment variant, it has proven to be advantageous if the chelating agent has an organic amino function and is preferably selected from the group including amino carboxylic acids, amino phosphonic acids or a combination thereof.

In this way, it was possible to produce especially advantageously a liquid detergent concentrate.

It has proven to be advantageous if the polymeric dispersing agent is a polycarboxylic acid, preferably polyacrylic acid or a derivative thereof.

(iii) 0 to 5% by Weight Tenside:

The proportion of tensides must not be too high due to the foaming behaviour and the stability as well as due to cost-effective and environmental reasons. There is preferably used up to 2% by weight, especially preferred 0.5 to 1.5% by weight. As such, there may be used well-known tensides for dish detergents. In an embodiment variant, however, it has proven to be advantageous if the tenside does not represent a non-ionic tenside but rather preferably a fatty alcohol alkoxylate or a derivative thereof. Fatty alcohol alkoxylate 8 (Plurafac LF 400, company BASF) has been shown to be an especially suitable tenside.

### (iv) 0 to 5% by Weight Excipients:

For the excipients, there may be made reference to the explanations given above.

There are preferably used between 1 and 3% by weight of excipient. Monoethanol amine is especially preferably added.

### (v) 28 to 39% by Weight Water:

The water content is preferably 28 to 39% by weight, wherein concentrations below 28% by weight did not have the desired viscosities any longer. Concentrations above 39% by weight may be produced as suspensions, but the advantage over a solution will not be very great, however.

In an embodiment variant there is provided that the liquid detergent concentrate is free of ethanol, glycerin, and other short-chain alcohols (Ci- to C5 alcohols), as it has been shown that such alcohols will increase the viscosity, i.e. act as thickening agents. It has been also shown that the introduction of NaOH solutions into alcohols, polyols or glycerine while adding solid NaOH will lead to uncontrollable curing and an inhomogeneous thickening.

In a preferred embodiment variant, the detergent concentrate has no further ingredients but those mentioned above.

### Experiment Results and Example Embodiments

The liquid detergent concentrate represented above is a stable suspension and has a viscosity such that it may be pumped in a metering device, thus being meterable. For this reason, there is preferably provided that the viscosity of the detergent concentrate is at the most 6500 mPa·s, measured according to ISO 2555:1989 at 20° C. at a rotational speed of 5 rpm.

### EXAMPLES

In the following, there are shown as examples formulations as well as methods of production for detergent concentrates according to the invention as well as the rheological properties thereof, in a comparison with comparative examples that are not according to the invention.

### Example 1: Example According to the Invention

| | Proportion | Proportion | | |
|---|---|---|---|---|
| | raw material¹ | ingredient² | | |
| | [% | [% | | |
| Ingredient | by weight] | by weight] | Function | Step |
| Alanine N,N-carboxymethyl- | 27.0 | 10.8 | K | a) |
| trisodium salt³ in aqueous | | | | |
| solution (40% by weight) | | | | |
| Amino phosponic acid salt⁴ in | 10.0 | 4.2 | K | |
| aqueous solution (42% by | | | | |
| weight) | | | | |
| Monoethanol amine | 2.2 | 2.2 | H | b) |
| Polymeric phosphonic acid⁵; | 5.0 | 3.0 | K | c) |
| hydrochloric acid; in aqueous | | | | |
| solution (60% by weight) | | | | |
| Caustic soda (50% by | 22.3 | 11.15 | XOH | d) |
| weight) | | | | |
| Isotridecanol ethoxylate⁶ | 1.5 | 1.5 | T | e) |
| Potassium hydroxide | 10.0 | 10.0 | XOH | f) |
| Polyacrylic acid⁹, sodium salt | 3.0 | 1.65 | K | g) |
| (in aqueous solution, 55% by | | | | |
| weight) | | | | |
| Sodium hydroxide | 19.0 | 19.0 | XOH | h) |
| Total | 100 | 63.5 | | |

¹ingredient including water
²pure ingredient (free of water)
³Trilon M, aqu.
⁴Dequest 2066
⁵Hydrodis WP 40
⁶Lutensol TO 7
⁹Sokalan PA 30 CL (aqueous solution).
K chelating agent/dispersing agent
H excipient
T tenside
XOH alkali metal hydroxide
Step method step according to claim 10

The total water content was 36.5% by weight. In the production process, there was carried out cooling such that the maximum temperature did not exceed 35° C. The viscosity of the suspension was:

Viscosity (mPa·s): 4500 mPa·s, measured according to ISO 2555:1989 at 20° C. and 5 rpm

### Example 2: Example According to the Invention

| | Proportion | Proportion | | |
|---|---|---|---|---|
| | raw material¹ | ingredient² | | |
| | [% | [% | | |
| Ingredient | by weight] | by weight] | Function | Step |
| Alanine N,N-carboxymethyl- | 27.0 | 10.8 | K | a) |
| trisodium salt³ in aqueous | | | | |
| solution (40% by weight) | | | | |
| Amino phosponic acid salt⁴ in | 10.0 | 4.2 | K | |
| aqueous solution (42% by | | | | |
| weight) | | | | |
| Monoethanol amine | 2.2 | 2.2 | H | b) |
| Polymeric phosphonic acid⁵; | 5.0 | 3.0 | K | c) |
| hydrochloric acid; in aqueous | | | | |
| solution (60% by weight) | | | | |
| Caustic soda (50% by | 22.3 | 11.15 | XOH | d) |
| weight) | | | | |
| Isotridecanol ethoxylate⁶ | 0.5 | 0.5 | T | e) |
| Potassium hydroxide | 8.0 | 8.0 | XOH | f) |
| Polyacrylic acid⁹, sodium salt | 5.0 | 2.75 | K | g) |
| (in aqueous solution, 55% by | | | | |
| weight) | | | | |
| Mixture on the basis of | 1.0 | 1.0 | H | g |
| sodium carbonate⁸; without | | | | |
| phosphate | | | | |
| Sodium hydroxide | 19.0 | 19.0 | XOH | h) |
| Total | 100 | 62.6 | | |

¹ingredient including water
²pure ingredient (free of water)
³Trilon M, aqu.
⁴Dequest 2066
⁵Hydrodis WP 40
⁶Lutensol TO 7
⁷Sokalan PA 25 CL (granula)
⁸Mirapol Surf S
⁹Sokalan PA 30 CL (aqu. solution)
K chelating agent/dispersing agent
H excipient
T tenside
XOH alkali metal hydroxide

The total water content was 37.4% by weight. In the production process, there was carried out cooling such that the maximum temperature did not exceed 35° C. The viscosity of the suspension was:

Viscosity (mPa·s): 6000 mPa·s, measured according to ISO 2555:1989 at 20° C. and 5 rpm

### Example 3: Example According to the Invention

| | Proportion | Proportion | | |
|---|---|---|---|---|
| | raw material¹ | ingredient² | | |
| | [% | [% | | |
| Ingredient | by weight] | by weight] | Function | Step |
| Alanine N,N-carboxymethyl- | 27.0 | 10.8 | K | a) |
| trisodium salt³ in aqueous | | | | |
| solution (40% by weight) | | | | |
| Amino phosponic acid salt⁴ in | 10.0 | 4.2 | K | |
| aqueous solution (42% by | | | | |
| weight) | | | | |
| Monoethanol amine | 2.2 | 2.2 | H | b) |
| Polymeric phosphonic acid⁵; | 5.0 | 3.0 | K | c) |
| hydrochloric acid; in aqueous | | | | |
| solution (60% by weight) | | | | |
| Caustic soda (50% by | 22.3 | 11.15 | XOH | d) |
| weight) | | | | |
| Isotridecanol ethoxylate⁶ | 1.5 | 1.5 | T | e) |
| Potassium hydroxide | 8.0 | 8 | XOH | f) |
| Polyacrylic acid⁹, sodium salt | 5.0 | 2.75 | K | g) |
| (in aqueous solution, 55% by | | | | |
| weight) | | | | |
| Sodium hydroxide | 19.0 | 19.0 | XOH | h) |
| Total | 100 | 62.6 | | |

¹ingredient including water
²pure ingredient (free of water)
³Trilon M, aqu.
⁴Dequest 2066
⁵Hydrodis WP 40
⁶Lutensol TO 7
⁹Sokalan PA 30 CL aqueous solution
⁸Mirapol Surf S
K chelating agent
H excipient
T tenside
XOH alkali metal hydroxide

The total water content was 37.45% by weight. In the production process, there was carried out cooling such that the maximum temperature did not exceed 35° C. The viscosity of the suspension was:

Viscosity (mPa·s): 3800 mPa·s, measured according to ISO 2555:1989 at 20° C. and 5 rpm

### Comparative Example 1

| | Proportion | Proportion | | |
|---|---|---|---|---|
| | raw material¹ | ingredient² | | |
| | [% | [% | | |
| Ingredient | by weight] | by weight] | Function | Step |
| Water | 35.0 | — | LM | 1 |
| Polymeric phosphonic acid in | 10.0 | 5.0 | K | 2 |
| aqueous solution (50% by | | | | |
| weight) | | | | |
| Glycerol | 5.0 | 5.0 | K | 3 |
| Potassium hydroxide | 10.0 | 10.0 | XOH | 4 |
| Polyacrylic acid, sodium | 20.0 | 20.0 | K | 5 |
| salt ⁴⁾ | | | | |
| Sodium hydroxide | 20.0 | 20.0 | XOH | 6 |
| Total | 100 | 60.0 | | |

¹ingredient including water
²pure ingredient (free of water)
³⁾ Hydrodis ADW 3814/N
⁴⁾ Sokalan PA 25 CL (granula)
K chelating agent
LM solvent
XOH alkali metal hydroxide

The total water content was 40.0% by weight.

In the preparation of the concentrate of comparative example 1, there was not provided any temperature control. In the production process, the temperature was 75° C. at the most. Already immediately after preparation, the concentrate was highly viscous; after 24 hours, the composition was gel-like. The presence of glycerol seems to have a negative effect on the stability of the viscosity.

### Comparative Example 2

| | Proportion | Proportion | | |
|---|---|---|---|---|
| | raw material¹ | ingredient² | | |
| | [% | [% | | |
| Ingredient | by weight] | by weight] | Function | Step |
| Alanine N,N-carboxymethyl- | 27.0 | 11.1 | K | a) |
| trisodium salt³ in aqueous | | | | |
| solution (40% by weight) | | | | |
| Amino phosponic acid salt⁴ in | 10.0 | 4.2 | K | |
| aqueous solution (42% by | | | | |
| weight) | | | | |
| Monoethanol amine | 2.2 | 2.2 | H | b) |
| Polymeric phosphonic acid⁵; | 5 | 3 | K | c) |
| hydrochloric acid; in aqueous | | | | |
| solution (60% by weight) | | | | |
| Caustic soda (50% by | 22 | 11.0 | XOH | d) |
| weight) | | | | e) |
| Mixture on the basis of | 0.8 | 0.8 | H | |
| sodium carbonate⁶; without | | | | |
| phosphates | | | | |
| Potassium hydroxide | 7.5 | 7.5 | XOH | f) |
| Polyacrylic acid⁷, sodium salt | 5.8 | 5.8 | K | g) |
| Sodium hydroxide | 19 | 19.0 | XOH | h) |
| Total | 100 | 64.6 | | |

¹ingredient including water
²pure ingredient (free of water)
³Trilon M, aqu.
⁴Dequest 2066
⁵Hydrodis WP 40
⁶Mirapol Surf S
⁷Sokalan PA 25 CL granule
K chelating agent
H excipient
XOH alkali metal hydroxide

Total water content: 35.4% by weight.

The preparation was free of tensides. The formulation was too viscous without any temperature control during preparation. Using temperature control in the production method (maximum temperature of 35° C.), the viscosity of the suspension was still in the range of 6500 mPa·s. The complete absence of tensides, however, had a negative effect on the viscosity. An addition of 0.5% by weight showed a reduction of viscosity and an increase of stability.

A reduction of the water content in detergent concentrates on the basis of water usually results in an increase in viscosity. In the DE 100 02 710 A1 there is described a cream-like detergent concentrate having a water proportion of 32.5%. The property as a cream or paste, however, is unsuitable for the use in metering device due to the high viscosity. Such a detergent could not be metered using a pinch pump in the metering device.

A detergent concentrate prepared according to the method according to the invention shows two differences to the cream- or paste-like detergents according to the DE 100 02 710 A1: Firstly, in the DE 100 02 710 A1 there is prepared a homogenous mixture without particles, i.e. no suspension. Secondly, the detergent concentrate of the DE 100 02 710 A1 has a considerably higher viscosity, resulting in the poor metering ability.

In the following table 1, there are compared a detergent concentrate according to the invention and the detergent concentrate according to the DE 100 02 710 A1.

TABLE 1
Comparison of the viscosity of detergent concentrates:

| | Composition | Example of the |
|---|---|---|
| | example 1 | DE 100 02 710 A1 |
| Viscosity (mPa · s)* | 2671 +/− 35 | 20,000 to 90,000 |
| | (suspension) | (cream-like paste) |

Measurement conditions as in the DE 100 02 710 A1:

Brookfield Viscometer according to ISO 2555:1989.

The individual measurement results for the example 1 are as follows:

| Result example 1 | Viscosity, mPa · s |
|---|---|
| Measurement 1 | 2651 |
| Measurement 2 | 2711 |
| Measurement 3 | 2651 |

The composition according to example 3 was prepared in addition under different conditions, i.e. at different temperatures. The addition steps d) to h) were carried out such that in the aqueous phase there was not exceeded a temperature of 40° C. (see table 2).

TABLE 2
Comparison of viscosity-composition according to example 3.

| Results: | Viscosity (mPa · s) at 5 rpm, 20° C.* |
|---|---|
| Sample 1 | 2184 |
| Sample 2 | 6360 |
| Sample 3 | 2400 |
| Sample 4 | 3030 |

*Measurement conditions: Brookfield Viscometer according to ISO 2555: 1989.

In the samples 1, 3 and 4, there was a maximum temperature of 35° C., in sample 2 the temperature increased to 40° C. for a short period of time. The measurement values correlate with the maximum temperature, i.e. in sample 1 the temperatures were the lowest, in sample 2 the highest.

### Comparative Example 3

Compositions are made according to the examples in U.S. Publication No. 2014/0121150 to Walters et al., but using amounts of water from 28% to 39% in 1% increments. Every composition was either a solid or semi-solid with either an unmeasurable viscosity, or a viscosity of a very thick paste, such as what is disclosed in DE 100 02 710 A1, with a viscosity of at least 100,000 mPa·s when measured using a Brookfield Viscometer according to ISO 2555:1989.

1. A stable liquid detergent concentrate comprising:
(i) 22 to 46% by weight alkaline metal hydroxide;
(ii) 5 to 50% by weight dispersing agent, chelating agent, or a combination thereof;
(iii) 0 to 5% by weight tenside;
(iv) 0 to 5% by weight excipients; and
(v) 28 to 39% by weight water,
wherein the detergent concentrate is a liquid suspension that combines each of components (i) through (v), and
wherein the suspension has a viscosity of at most 6500 mPa·s, as measured according to ISO 2555:1989 at 20° C. at a rotational speed of 5 rpm.

2. The stable liquid detergent concentrate of claim 1, wherein the alkaline metal hydroxide is sodium hydroxide, potassium hydroxide, or a mixture thereof.

3. The stable liquid detergent concentrate of claim 2, wherein the detergent concentrate comprises:
20 to 41% by weight sodium hydroxide; and
5 to 10% by weight potassium hydroxide.

4. The stable liquid detergent concentrate of claim 1, wherein the dispersing agent comprises at least a chelating agent and polymeric dispersing agent.

5. The stable liquid detergent concentrate of claim 4, wherein the detergent concentrate comprises:
5 to 49% by weight chelating agent; and
1 to 10% by weight polymeric dispersing agent.

6. The stable liquid detergent concentrate of claim 4, wherein the chelating agent has an organic amino function.

7. The stable liquid detergent concentrate of claim 5, wherein the polymeric dispersing agent is a polycarboxylic acid.

8. The stable liquid detergent concentrate of claim 1, wherein the excipient is monoethanol amine.

9. The stable liquid detergent concentrate of claim 1, wherein the chelating agent is selected from the group consisting of amino carboxylic acids, amino phosphonic acids, and combinations thereof.

10. The stable liquid detergent concentrate of claim 5, wherein the polymeric dispersing agent is a polyacrylic acid.

11. The stable liquid detergent concentrate of claim 1, wherein the suspension is formed by a process comprising the steps of:
a) providing a portion of a dispersing agent, chelating agent or a combination thereof in an aqueous solution,
b) optionally adding excipients,
c) in the case of the addition of excipients, subsequently adding a further portion of a dispersing agent,
d) adding a portion of an alkaline metal hydroxide as an aqueous solution,
e) optionally adding a tenside,
f) adding a portion of an alkaline metal hydroxide as a solid,
g) adding a dispersing agent,
h) adding a further portion of an alkaline metal hydroxide,
wherein the steps of adding are carried out while stirring and wherein at least the addition steps d) to h) are carried out such that in the aqueous phase there is maintained a temperature of at most 40° C.

12. The stable liquid detergent concentrate of claim 11, wherein the temperature is maintained at least in part using active external cooling.

13. The stable liquid detergent concentrate of claim 11, wherein viscosity of the suspension and density of the suspension change by less than 5% upon 30 days of storage at 20° C.

14. The stable liquid detergent concentrate of claim 1, wherein the suspension does not separate or precipitate during storage.

15. The stable liquid detergent concentrate of claim 1, wherein the suspension is capable of being metered using a pinch pump.

16. A liquid detergent concentrate comprising:
(i) 22 to 46% by weight alkaline metal hydroxide;
(ii) 5 to 50% by weight dispersing agent, chelating agent, or a combination thereof;
(iii) 0 to 5% by weight tenside;
(iv) 0 to 5% by weight excipients; and
(v) 28 to 39% by weight water,
wherein the detergent concentrate is a liquid suspension having a viscosity of at most 6500 mPa·s, as measured according to ISO 2555:1989 at 20° C. at a rotational speed of 5 rpm,
wherein the liquid suspension is formed by a process comprising the steps of:
a) providing a portion of the dispersing agent, chelating agent, or combination thereof in an aqueous solution,
b) optionally adding excipients,
c) in the case of the addition of excipients, subsequently adding a further portion of a dispersing agent,
d) adding a portion of the alkaline metal hydroxide as an aqueous solution,
e) optionally adding a tenside,
f) adding a portion of the alkaline metal hydroxide as a solid,
g) adding a dispersing agent,
h) adding a further portion of the alkaline metal hydroxide,
wherein the steps of adding are carried out while stirring and wherein at least the addition steps d) to h) are carried out such that in an aqueous phase there is maintained a temperature of at most 40° C.

17. The liquid detergent concentrate of claim 16, wherein the alkaline metal hydroxide comprises sodium hydroxide, potassium hydroxide, or a mixture thereof.

18. The liquid detergent concentrate of claim 16, wherein the detergent concentrate comprises:
5 to 49% by weight chelating agent and
1 to 10% by weight polymeric dispersing agent.

19. The liquid detergent concentrate of claim 16, wherein the suspension is stable and does not separate or precipitate during storage.

20. The liquid detergent concentrate of claim 16, wherein the suspension is stable so that the viscosity changes less than 5% upon 30 days of storage.
